(19) United States
(12) Patent Application Publication
(10) Pub. No.: US 2023/0412552 A1
(43) Pub. Date: Dec. 21, 2023

(54) MESSAGING PROTOCOL TO FACILIATE DEMAND-BASED MESSAGING

(71) Applicant: Krier, Godfrey & Grassbaugh, Inc., Granville, OH (US)

(72) Inventors: Andrew Glassman, Elm Grove, WI (US); Michael Hawk, Granville, OH (US)

(21) Appl. No.: 17/842,661

(22) Filed: Jun. 16, 2022

(51) Int. Cl. H04L 51/234; G06Q 20/08; G06F 3/0484

(52) U.S. Cl. CPC H04L 51/234; G06F 3/0484; G06Q 20/0855

(57) ABSTRACT

Embodiments of the present disclosure provide techniques for sending/receiving messages in a messaging platform that uses message types that are defined by different cost transactions and message criteria to incentivize receivers of messages of those types to prioritize such messages. A receiver device may receive information defining each of a set of message types, while a sender device may receive, via a user interface (UI) for selecting among the set of messages types, a selection of a message type from the set of messages types and message content. The sender device may transmit a message having the selected message type and the message content to a receiver device via a messaging platform. The messaging platform may create a message transaction to monitor whether message criteria associated with the selected message type has been satisfied and if so, the messaging platform may process the cost transaction associated with the selected message type between the sender device and the receiver device.

### TECHNICAL FIELD

Aspects of the present disclosure relate to a messaging platform, and more particularly, to a messaging platform that implements a communication protocol that assists users in prioritizing received communications while preventing spam, junk, and other unwanted communications from occupying space in a user's inbox.

### BACKGROUND

A communication protocol is a system of rules that allows two or more entities of a communications system to transmit information via any kind of physical link. A communication protocol may define the rules, syntax, semantics, and synchronization of communication between two or more entities of the communications system. Communication protocols may utilize any appropriate framework such as the Open Systems Interconnection (OSI) model to operate. The application layer of the OSI model may provide services to application processes including identification of the intended communication partners, establishment of the necessary authority to communicate, determination of availability and authentication of the partners, agreement on privacy mechanisms for the communication, and agreement on responsibility for error recovery and procedures for ensuring data integrity, among others.

A messaging application may use any appropriate protocol to transmit and receive messages. For example, some messaging applications utilize the Extensible Messaging and Presence Protocol (XMPP), which is an open communication protocol defined in the application layer and designed for instant messaging (IM), presence information, and contact list maintenance. XMPP enables the near-real-time exchange of structured data between two or more network entities. Messaging applications may also utilize any appropriate cryptographic protocol to provide end-to-end encryption of instant messaging conversations and voice/video calls.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1A is a block diagram that illustrates an example system, in accordance with some embodiments of the present disclosure.

FIG. 1B is a block diagram that illustrates defining a message type using the system of FIG. 1A, in accordance with some embodiments of the present disclosure.

FIG. 2A is a diagram that illustrates a user profile, in accordance with some embodiments of the present disclosure.

FIG. 2B is a diagram that illustrates an external version of the user profile of FIG. 2A via which a sender of a message may select a message type, in accordance with some embodiments of the present disclosure.

FIG. 2C is a detailed block diagram of a system, in accordance with some embodiments of the present disclosure.

FIG. 2D is a diagram of a message que, in accordance with some embodiments of the present disclosure.

FIG. 3 is a diagram that illustrates the use of a message transaction to determine whether the message criteria of a sent message has been satisfied, in accordance with some embodiments of the present disclosure.

FIG. 4 is a flow diagram of a method for sending/receiving messages in a messaging platform that uses message types that are defined by cost transactions and message criteria to incentivize receivers of messages of those types to prioritize such messages by processing the associated cost transaction based on whether the message criteria associated with the message type is met, in accordance with some embodiments of the present disclosure.

FIG. 5 is a block diagram of an example computing device that may perform one or more of the operations described herein, in accordance with some embodiments of the present disclosure.

### DETAILED DESCRIPTION

Electronic messaging systems such as instant messaging (e.g., the WhatsApp™ platform) and e-mail often suffer from a large number of unwanted or low priority messages. This is particularly the case in messaging systems that are integrated into social media platforms such as the Instagram™ platform. As a result, there are numerous mechanisms for filtering such unwanted messages. Most of these filtering mechanisms are based on intensive processing and analysis of messages to identify and remove unwanted messages, while allowing desired messages to proceed unhindered. In particular, these filtering mechanisms include anti-virus filtering mechanisms to automatically block messages containing viruses, worms, phishing attacks, spyware and Trojans as various forms of malicious message content. Further, anti-spam filtering mechanisms identify and block delivery of junk e-mail messages containing unsolicited advertising for products and services.

However, regardless of the techniques used to filter spam, most messaging systems are subject to some level of spam/unwanted messages. In addition, many users of a messaging system are subject to a high volume of messages from other ordinary (i.e., non-business/advertising) users of the messaging system that do not constitute spam and thus will not be blocked by a spam filter or similar technology. For example, a user who has a popular cooking show may receive thousands of messages a day from fans of the show via any number of platforms. In such scenarios, it is difficult for a user to prioritize messages including which messages need to be viewed and/or responded to, and in what order.

The present disclosure addresses the above-noted and other deficiencies by providing techniques for sending/receiving messages in a messaging platform that uses message types that are defined by different cost transactions and message criteria to incentivize receivers of messages of those types to prioritize such messages by processing the associated cost transaction based on whether the message criteria associated with the message type is met. A receiver device may receive information defining each of a set of message types, wherein each of the set of message types comprises a cost transaction and message criteria for executing the cost transaction. A sender device may receive, via a user interface (UI) for selecting among the set of messages types, a selection of a message type from the set of messages types and message content. The sender device may transmit a user message having the selected message type and the message content to a receiver device via a messaging platform. The messaging platform may create a message transaction to monitor one or more actions taken by the receiver device with respect to the user message to determine whether message criteria associated with the selected message type has been satisfied. In response to determining that the message criteria associated with the selected message type has been satisfied, the messaging platform may process the cost transaction associated with the selected message type between the sender device and the receiver device.

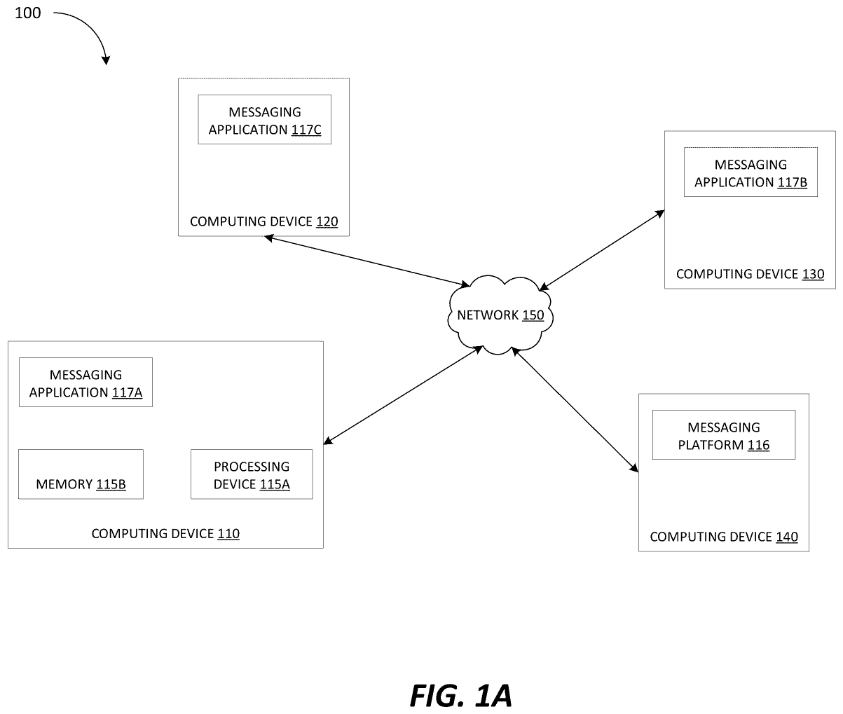

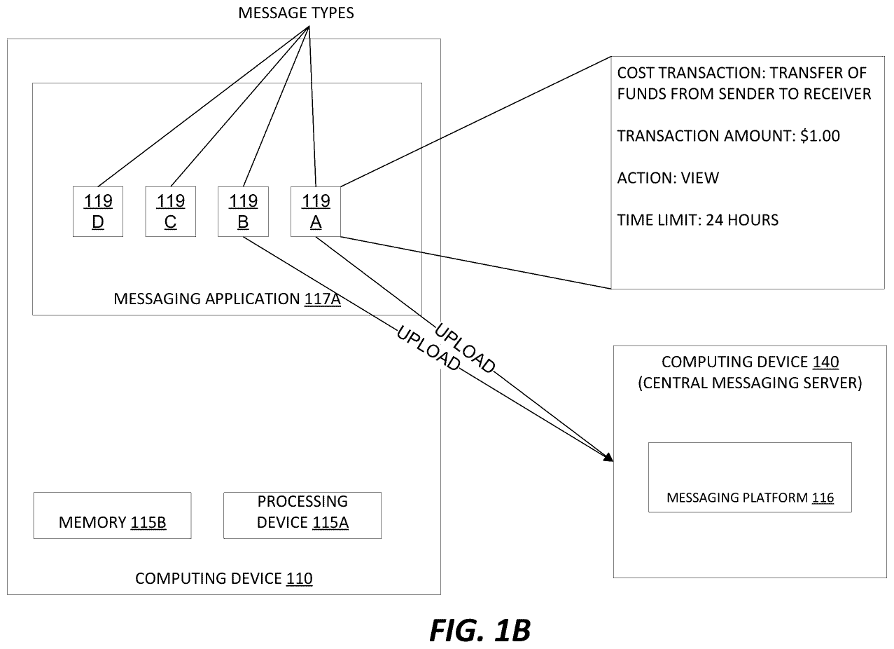

FIG. 1A is a block diagram that illustrates an example system 100. As illustrated in FIG. 1A, the system 100 includes computing devices 110, 120, 130, and 140. The computing devices 110-140 may be coupled to each other (e.g., may be operatively coupled, communicatively coupled, may communicate data/messages with each other) via network 150. Network 150 may be a public network (e.g., the internet), a private network (e.g., a local area network (LAN) or wide area network (WAN)), or a combination thereof. In one embodiment, network 150 may include a wired or a wireless infrastructure, which may be provided by one or more wireless communications systems, such as a WiFi′ hotspot connected with the network 150 and/or a wireless carrier system that can be implemented using various data processing equipment, communication towers (e.g. cell towers), etc. The network 150 may carry communications (e.g., data, message, packets, frames, etc.) between the computing devices 110-140. Each of the computing devices 110-140 may include hardware such as processing device 115A (e.g., processors, central processing units (CPUs), memory 115B (e.g., random access memory (RAM), storage devices (e.g., hard-disk drive (HDD), solid-state drive (SSD), etc.)), and other hardware devices (e.g., sound card, video card, etc.). A storage device may comprise a persistent storage that is capable of storing data. A persistent storage may be a local storage unit or a remote storage unit. Persistent storage may be a magnetic storage unit, optical storage unit, solid state storage unit, electronic storage units (main memory), or similar storage unit. Persistent storage may also be a monolithic/single device or a distributed set of devices. The memory 115B (as well as the corresponding memory of each of the computing devices 120-140) may include a peer to peer chunked file transfer software module (not shown) which may be executed by the processing device 115A to perform certain functions described herein.

FIG. 1A and the other figures may use like reference numerals to identify like elements. A letter after a reference numeral, such as “110A,” indicates that the text refers specifically to the element having that particular reference numeral. A reference numeral in the text without a following letter, such as “110,” refers to any or all of the elements in the figures bearing that reference numeral.

Each of the computing devices 110-140 may comprise any suitable type of computing device or machine that has a programmable processor including, for example, server computers, desktop computers, laptop computers, tablet computers, smartphones, set-top boxes, vehicles etc. In some examples, the computing devices 110-140 may each comprise a single machine or may include multiple interconnected machines (e.g., multiple servers configured in a cluster). The computing devices 110-140 may be implemented by a common entity/organization or may be implemented by different entities/organizations. For example, computing device 120 may be operated by a first company/corporation while computing device 130 may be operated by a second company/corporation. The computing devices 110-140 may each execute or include an operating system (OS) (not shown in the FIGS.). The OSs of computing devices 110-140 may manage the execution of other components (e.g., software, applications, etc.) and/or may manage access to the hardware (e.g., processors, memory, storage devices etc.) of their respective computing device.

Continuing to refer to FIG. 1A, the computing device 140 may act as a central messaging server and execute a messaging platform 116 that integrates functionality for defining different types of messages and processing transactions between senders and receivers of messages based on the type of message sent/received as discussed in further detail herein. In some embodiments, the messaging platform 116 may be based on (e.g., may be a modification of) any appropriate messaging protocol such as the XMPP protocol. The messaging platform 116 may comprise local messaging applications 117A-117C, each of which may execute on a respective computing device 110-130 and correspond to a messaging platform account of the user of the respective computing device 110-130. Each messaging application 117A-117C may be a software module stored in the memory of a respective computing device (e.g., memory 115B) and executed by a respective processing device (e.g., processing device 115A) of a computing device in order to perform some of the functions described herein. For example, each of the messaging applications 117A-117C may provide functionality for displaying/editing a user profile associated with the messaging platform account of the respective user, defining different types of messages, navigating to other users' profiles (based on e.g., interaction with a message link), and selecting among message types defined by a particular user (and displayed in the particular user's user profile) in order to send a message to the particular user, as discussed in further detail herein. Each different type of message may specify a cost transaction that will be executed between the sender and the receiver of a message (i.e., the “cost” to the sender of transmitting a message of that type to the receiver), and message criteria defining an action(s) that must be taken (e.g., viewing or responding to) with respect to the message along with other parameters that must be fulfilled by the receiver of the message in order for the cost transaction to be processed, as discussed in further detail herein. The cost transaction that will be executed between the sender and receiver of a message of a particular type may be any appropriate transaction such as payment of money. By requiring the sender of a message of a message type as described herein to invest resources in order for the receiver to take some action on the message (e.g., view the message, reply to the message), the messaging platform 116 may assist the receiver (e.g., the user of the computing device 110) in prioritizing messages by ensuring that only users who have a serious/genuine reason for reaching out to the receiver (i.e., users who are willing to invest resources) can message the receiver. It should be noted that although the embodiments of the present disclosure are described with respect to local messaging applications 117, in some embodiments each computing device may access the messaging platform 116 via a browser and implement the same functionality as described herein with respect to the messaging applications 117.

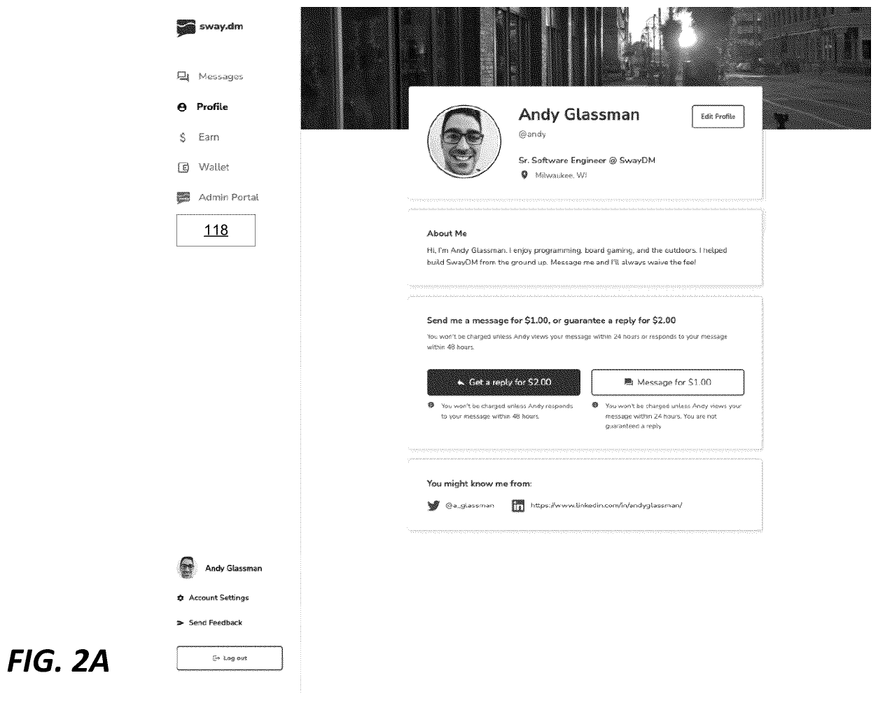

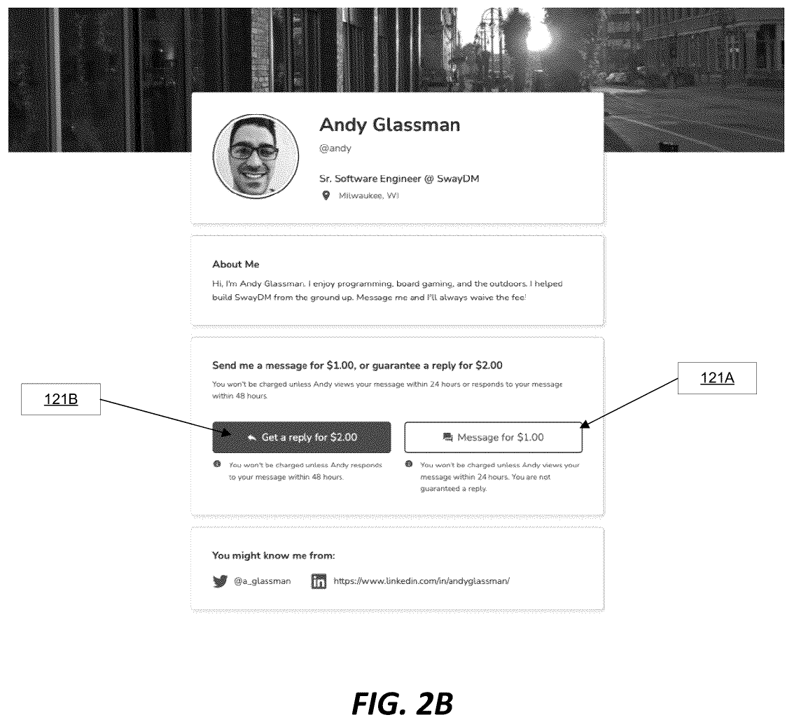

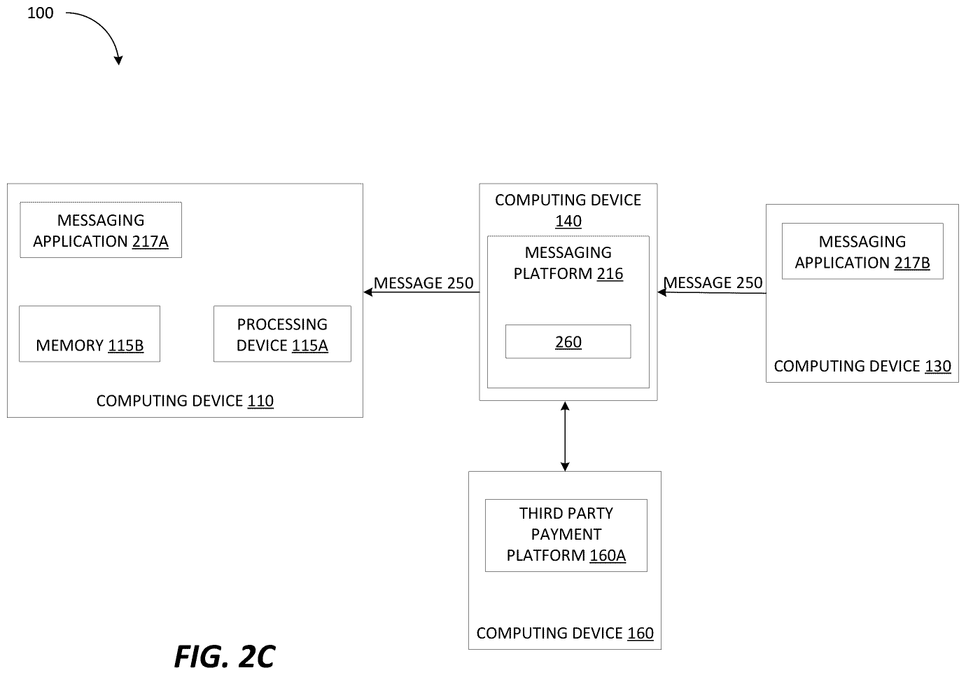

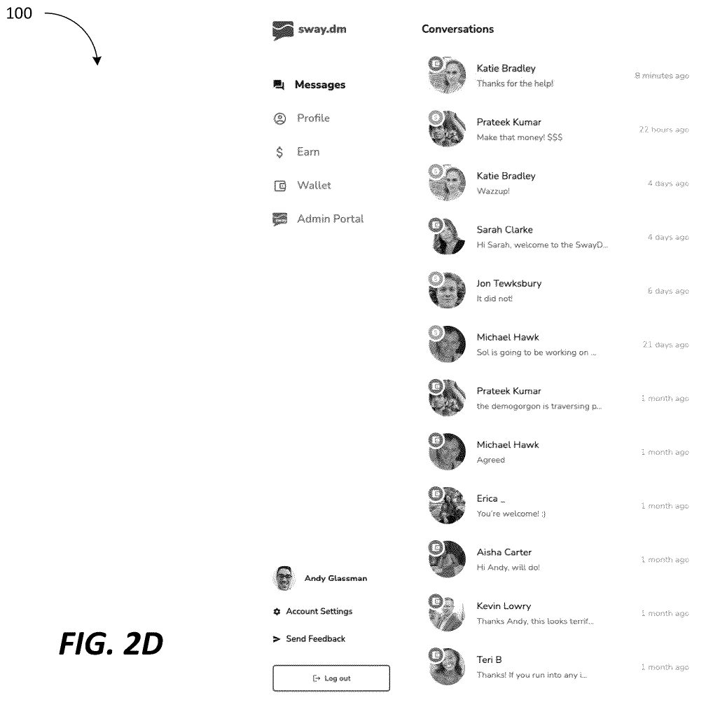

Each of the messaging applications 117 may generate a user profile for a user of their respective computing device 110-130. FIG. 2A illustrates an example user profile 200 which may be a user profile of the receiver (i.e., the user of computing device 110), and which may comprise a user interface that displays the receiver's user information including their first and last names, title, username, organization, location (e.g., city, state, country), and social media URLs and handles, among other information. The user interface may also include an interactable graphical user interface (GUI) feature (shown as button 118 in the example of FIG. 2A) that allows the user to define message types as discussed in further detail herein. Other interactable GUI features may allow the receiver to edit the user information displayed in their profile, allow the receiver to view their received messages, and provide options for a sender of a message to select a type of message to send to the receiver as discussed in further detail herein.

Referring now to FIG. 1B, upon executing the messaging application 117A, the receiver may be directed to their user profile (e.g., user profile 200 as discussed with respect to FIG. 2A). The receiver may select button 118 in order to define a new message type, and in response to the user selecting the button 118, the messaging application 117A may provide a second user interface (not shown in the FIGS.) which may prompt the user to provide information defining the message type. The information defining the message type may comprise a cost transaction that may be executed between a sender and a receiver of a message (in this case, the receiver) of the defined type, and message criteria that must be fulfilled by the receiver of the message of the defined type in order for the cost transaction to be executed. The messaging platform 116 may monitor for whether the message criteria associated with a message has been fulfilled and may integrate with any appropriate third party service in order to facilitate processing of the cost transaction once the message criteria has been fulfilled. It should be noted that in the examples described herein, the cost transaction to be executed may be payment of money via e.g., a wallet of the sender of the message to a wallet of the receiver of the message, however this is not a limitation and any appropriate transaction may be specified.

Each user of the messaging platform 116 (e.g., the sender and receiver) may have a payer wallet and an earner wallet associated with their messaging platform account, each of which may comprise a data structure in which funds may be stored electronically. All funds a user spends (e.g., by sending messages) may be stored in the payer wallet, and all funds a user earns (e.g., by viewing and/or replying to messages in a manner that meets the relevant message criteria) may be stored in the earner wallet. The messaging platform 116 may utilize adjustments to make modifications to the wallet balances of a user. An adjustment may correspond to an addition or deduction from the wallet balance of a user that is made outside of the normal charge/refund flow A user of the messaging platform 116 may load a balance into their paver wallet by interacting with the third party payment platform 160 which may facilitate electronic transfer of funds from a bank account of the uses into the payer wallet of the user. Similarly, a user of the messaging platform 116 may withdraw funds from their payer and/or earner wallet by interacting with the third party payment platform 1160 which may facilitate electronic transfer of funds from their payer and/or earner wallet to their bank account.

In the example of FIG. 1B, to define the message type the receiver may specify the cost transaction as payment of money from the sender of the message to the receiver of the message via a third party payments platform (as discussed in further detail herein) as well as the amount required to be paid. The receiver may also specify criteria that must be met in order for the cost transaction to be executed. The criteria that must be met in order for the cost transaction to be executed may be based on an action to be performed by the receiver, and a threshold amount of time within which the action must be performed by the receiver, for example. Examples of criteria that must be met in order for the cost transaction to be executed may include: an amount of time within which the message must be viewed by the receiver and an amount of time within which a reply to the message must be sent by the receiver. In some embodiments, the receiver may also define the message type to allow for proposed modifications to the cost transaction and/or the message criteria of the message type. For example, the messaging application 117B may provide a flexibility parameter, which when set for a message type may allow the sender to make proposed modifications to the cost transaction and/or the message criteria of the message type. For example, the flexibility parameter may allow the sender to offer more (or less) than the standard amount specified by the cost transaction for a response or view type message so that the message is given priority placement in the receiver's inbox. In addition, the message criteria may also be modified by the sender, so that e.g., a sender may offer more than the standard amount specified by the cost transaction while also proposing a shorter amount of time within which the receiver must either view or reply to the message. In some embodiments, the receiver may define ranges within which values associated with the cost transaction and/or the message criteria must fall. It should be noted that in some embodiments, the receiver may define a message type with a cost transaction and no message criteria, where a sender of this type of message pays for the privilege of sending the message with no guarantee of a view of or response to the message by the receiver.

As shown in FIG. 1B, the receiver may define a first message type 119A (also referred to herein as a view message type) which may cost a sender of a message of that type $1.00, and may require the receiver to view the message within 24 hours of receipt of the message in order for the $1.00 payment from the sender to the receiver to be processed via the messaging platform 116 between the payer wallet and earner wallet of the sender and the receiver respectively. The receiver may also define a second message type 119B (also referred to herein as a reply message type) which may cost a sender of a message of that type $2.00, and may require the receiver to reply to the message within 24 hours of receipt of the message in order for the $2.00 to be debited from the payer wallet of the sender to the earner wallet of the receiver. Referring back to FIG. 2A, the user profile 200 of the receiver may indicate the different messaging types available for communicating with the receiver (as defined by the receiver). Each of the different message type definitions 119 may be uploaded as a template to the messaging platform 116 on computing device 140 (central messaging server) so that they may be accessible and useable by other instances of the messaging application 117. In this way, as discussed in further detail herein, when a sender of a message decides upon a message type for a message they wish to send to the receiver, their local messaging application 117 may access the template definitions from the messaging platform 116 in order to generate a message of that type.

Referring to FIGS. 2B and 2C, the messaging application 117A may also provide the receiver with a link to their user profile 200 (hereinafter referred to as a messaging link) which the user may provide in a variety of third party channels. The messaging link may be a specialized link, interaction with which by a computing device may cause execution of a local messaging application 117 of the computing device to redirect the computing device to the receiver's user profile 200. For example, the receiver may post the link to their user profile in various social media applications, within emails that they send (e.g., as part of a signature block), on various websites, business cards, and in auto-responders of different types (e.g., email auto responders and direct messaging auto responders). In the example of FIG. 2C, the sender (i.e., the user of computing device 130) may visit a social media profile of the receiver where the messaging link has been posted and decide that they wish to message the receiver. The sender may click on the messaging link which may execute messaging application 117B and redirect the messaging application 117B to an external version of receiver's user profile 200 shown in FIG. 2B. The external version of the user profile 200 may include buttons 121A and 121B for selecting between message types 119A and 119B respectively for sending a message to the receiver. The sender may select a message type 119 by clicking on a corresponding button 121.

In response to receiving a selection of a message type from the sender, the messaging application 117B may access the corresponding message template from the messaging platform 116 and prompt the sender to enter message content (e.g., the text of the message to be sent). The messaging application 117B may then add the received message content to the message template to generate a message 250 and send the message 250 to the messaging platform 116 which may route the message 250 to the messaging application 117A. In some embodiments where the selected message type allows for proposed modifications, the messaging application 117B may also prompt the sender to enter their proposed modifications to the cost transaction and/or the message criteria.

Upon receiving the message from the messaging application 117B, the message platform 116 may generate a message transaction 260 to monitor whether the criteria for executing the cost transaction has been met. Message transactions may represent types of messages that have a lifecycle in the messaging platform 116 (e.g., view or reply message types) and may include a variety of states to indicate whether the criteria for executing the associated cost transaction has been met. Examples of such states may include pending, fulfilled (e.g., receiver viewed or replied to the message within the allotted time period), rejected (e.g., receiver waived the fee associated with the message type), and expired (e.g., receiver did not view or reply to the message within the allotted time period). The message transaction 260 may be generated based on the type of the message 250 as selected by the sender. For example, if the sender has sent message 250 having a view message type (i.e., message type 119A), the messaging platform 116 may create message transaction 260 as a view message transaction that monitors for when the message 250 has been viewed. In another example, if the sender has sent message 250 having a reply message type (i.e., message type 119B), the messaging platform 116 may create a reply message transaction that monitors for when a reply to the message 250 has been sent. Upon receiving the message 250 from the messaging platform 116, the messaging application 117A may add the received message to a message que of the receiver as shown in FIG. 2D.

The messaging application 117A may organize the message que of the receiver based on the type of each message received. For example, the messaging application 117A may display reply message types at the top of the message que, may display view message types below reply message types, and may display other message types below the reply and view message types. In some embodiments, the messaging application 117A may organize the messaging que such that message types that have the highest value cost transaction associated them are displayed at the top. The messaging application 117A may organize messages of the same type based on time/date received, whether the sender is in a preferred contacts list of the receiver, and any other appropriate factors. For each received message, the message que will indicate whether an action need to be taken or not, and what the action that needs to be taken is. It should be noted that a message can be viewed, replied, waived, or expired. In addition, a receive can reply as many times as they would like without charging the sender (e.g., the receiver may waive the cost transaction). However, if the receiver does not take the necessary action and fulfill the other message criteria (e.g., time limits), then the cost transaction will not be processed. All conversation messages, alerts, and updates to pricing may be transmitted in real time without the need of the messaging application 117 (or browser page) refreshing, or for the messaging application 117 (or browser page) to make a new request to the computing device 140 (central messaging server).

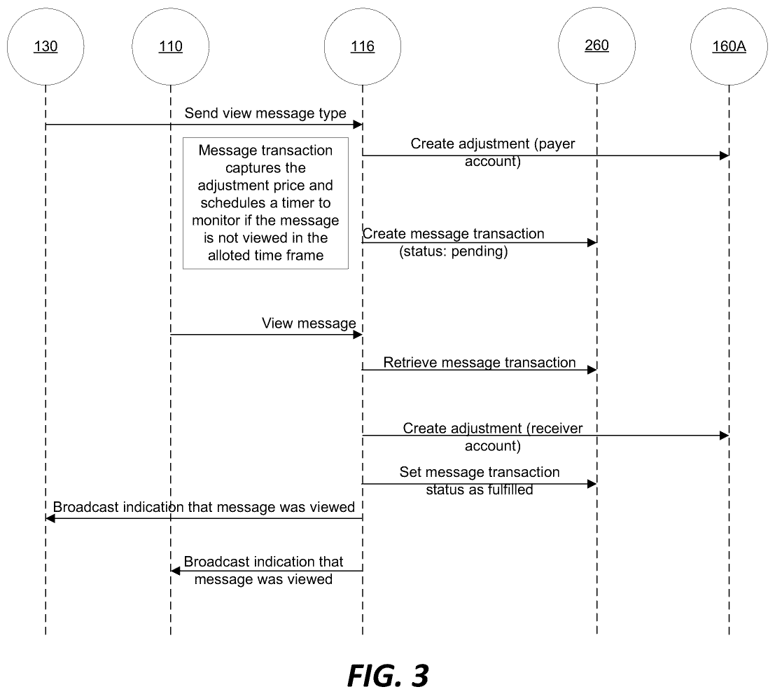

FIG. 3 is a diagram illustrating the generation and operation of the message transaction 260 to monitor the message criteria for a view message type message sent by the sender, in accordance with some embodiments of the present disclosure. Referring also to FIG. 2C, the sender may send (as discussed hereinabove) a message 250 having a view message type that specifies a cost transaction of $1.00 charged to a sender of a message of that type, and may define message criteria requiring the receiver to view the message within 24 hours of receipt of the message in order for the $1.00 payment from the sender to the receiver to be processed via the third party payment platform 160A. The message may be sent from messaging application 117B executing on computing device 130 to the computing device 140 (acting as a central messaging server) on which the messaging platform 116 executes. In addition to forwarding the message to the receiver at messaging application 117A executing on computing device 110, the messaging platform 116 may create an adjustment in the sender's payer wallet for $1.00 (the amount of the cost transaction). The adjustment may function as a holding charge, to ensure that the funds are available in the sender's payer wallet should the message criteria of the message be met. The messaging platform 116 may also create a message transaction 260 based on the view message type and initialize the message transaction with a current status of pending. More specifically, the messaging platform 116 may analyze the message 250, and generate the message transaction 260 based on the specified cost transaction and the message criteria. The message transaction 260 may capture the $1.00 adjustment and schedule a timer to monitor whether the message 250 has been viewed in the allotted time frame specified in the message criteria (in the current example, 24 hours).

When the receiver views the message 250, the messaging application 117B may send an indication that the message 250 has been viewed to the messaging platform 116, which may retrieve the message transaction 260 and inform it that the message 250 has been viewed. If the timer has not expired when the message transaction 260 learns that the message 250 has been viewed, the message transaction 260 may determine that the message criteria has been met. In response to the message transaction 260 determining that the message criteria has been met, the messaging platform 116 may retrieve the adjustment amount from the message transaction 260 and complete execution of the cost transaction associated with the view message type by creating a adjustment in the receiver's earner wallet to add $1.00 thereto, and debiting the $1.00 holding charge from the sender's payer wallet. The messaging platform 117 may set the status of the message transaction 260 to fulfilled and transmit an indication to the sender that the message 250 was viewed by the receiver.

When the receiver wishes to transfer the funds in their earner wallet to their bank account, the messaging application 117B may interface with the third party payment platform 160A and instruct the third party payment platform 160A to complete processing the transfer of the balance of the receiver's earner wallet to the receiver's bank account.

In some embodiments, the receiver may also define reply message types which the receiver may choose from when responding to a message received from the sender, regardless of the type of message the sender has sent. The reply message type may specify a cost transaction that must be fulfilled in order for the sender to view the receiver's reply message. For example, the receiver may define a reply message type that is only viewable by the sender when they pay to unlock it. It should be noted that the receiver and sender roles are fixed in relation to each other when a sender initiates a first message as part of an exchange between the two. Because these roles remain in place, it allows a receiver to send unfettered to “their” senders and allowing them to create one-to-many messaging schemes so that a receiver can re-engage their senders at scale.

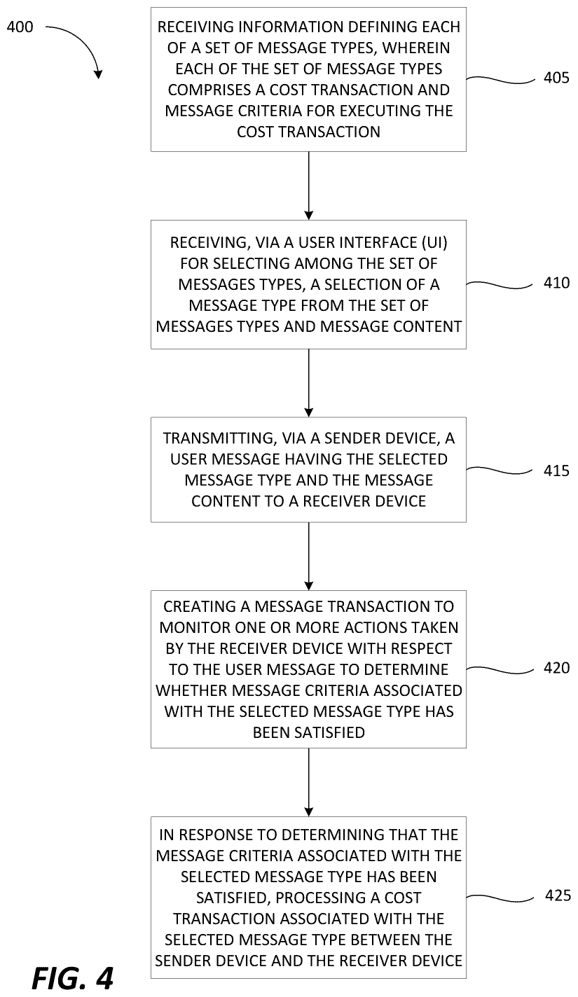

FIG. 4 is a flow diagram of a method 400 for sending/receiving messages in a messaging platform that uses message types defined by different cost transactions and message criteria to incentivize receivers of messages of those types to prioritize such messages by processing the associated cost transaction based on whether the message criteria associated with the message type is met, in accordance with some embodiments of the present disclosure. Method 400 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, the method 400 may be performed by computing devices 110, 130 and 140 illustrated in FIGS. 1A, 1B, and 2C.

Referring simultaneously to FIG. 2C, upon executing the messaging application 117A, the receiver may be directed to their user profile (e.g., user profile 200 as discussed with respect to FIG. 2A). The receiver may select button 118 in order to define a new message type, and in response to the user selecting the button 118, the messaging application 117A may provide a second user interface (not shown in the FIGS.) which may prompt the user to provide information defining the message type. Thus, at block 405 the computing device 110 may receive information defining the message type including a cost transaction that may be executed between a sender and a receiver of a message (in this case, the receiver) of the defined type, and message criteria that must be fulfilled by the receiver of the message of the defined type in order for the cost transaction to be executed. More specifically, the receiver may specify the cost transaction as payment of money from the sender of the message to the receiver of the message via a third party payments platform (as discussed in further detail herein) as well as the amount required to be paid. The receiver may also specify message criteria that must be met in order for the cost transaction to be executed. The message criteria that must be met in order for the cost transaction to be executed may be based on an action to be performed by the receiver, and a threshold amount of time within which the action must be performed by the receiver, for example. Examples of criteria that must be met in order for the cost transaction to be executed may include: an amount of time within which the message must be viewed by the receiver, for example.

The messaging application 117A may also provide the receiver with a link to their user profile 200 (hereinafter referred to as a messaging link) which the user may provide in a variety of third party channels. The messaging link may be a specialized link, interaction with which by a computing device may cause execution of a local messaging application 117 of the computing device to redirect the computing device to the receiver's user profile 200. For example, the receiver may post the link to their user profile in various social media applications and/or within emails that they send (e.g., as part of a signature block). In the example of FIG. 2C, the sender (i.e., the user of computing device 130) may visit a social media profile of the receiver where the messaging link has been posted and decide that they wish to message the receiver. The sender may click on the messaging link which may execute messaging application 117B and redirect the messaging application 117B to an external version of receiver's user profile 200 shown in FIG. 2B. The external version of the user profile 200 may include buttons 121A and 121B for selecting between message types 119A and 119B respectively for sending a message to the receiver. The sender may select a message type 119 by clicking on a corresponding button 121. At block 410, the computing device 130 may receive a selection of a message type from the sender, and the messaging application 117B may access the corresponding message template from the messaging platform 116 and prompt the sender to enter message content (e.g., the text of the message to be sent). At block 415, the messaging application 117B may then add the received message content to the message template to generate a message 250 and send the message 250 to the messaging platform 116 which may route the message 250 to the messaging application 117A. In addition to forwarding the message to the receiver at messaging application 117A executing on computing device 110, the messaging platform 116 may create an adjustment in the sender's payer wallet for $1.00 (the amount of the cost transaction). The adjustment may function as a holding charge, to ensure that the funds are available in the sender's payer wallet should the message criteria of the message be met.

At block 420, upon receiving the message from the messaging application 117B, the message platform 116 may generate a message transaction 260 to monitor whether the criteria for executing the cost transaction has been met. Message transactions may represent types of messages that have a lifecycle in the messaging platform 116 (e.g., view or reply message types) and may include a variety of states to indicate whether the criteria for executing the associated cost transaction has been met. Examples of such states may include pending, fulfilled (e.g., receiver viewed or replied to the message within the allotted time period), rejected (e.g., receiver waived the fee associated with the message type), and expired (e.g., receiver did not view or reply to the message within the allotted time period). The message transaction 260 may be generated based on the type of the message 250 as selected by the sender. For example, if the sender has sent message 250 having a view message type (i.e., message type 119A), the messaging platform 116 may create message transaction 260 as a view message transaction that monitors for when the message 250 has been viewed. The message transaction 260 may schedule a timer to monitor whether the message 250 has been viewed in the allotted time frame specified in the message criteria (in the current example, 24 hours). Upon receiving the message 250 from the messaging platform 116, the messaging application 117A may add the received message to a message que of the receiver as shown in FIG. 2D.

At block 425, in response to determining that the message criteria associated with the selected message type has been satisfied, the computing device 140 may process the cost transaction associated with the selected message type between the sender device and the receiver device. More specifically, when the receiver views the message 250, the messaging application 117B may send an indication that the message 250 has been viewed to the messaging platform 116, which may retrieve the message transaction 260 and inform it that the message 250 has been viewed. If the timer has not expired when the message transaction 260 learns that the message 250 has been viewed, the message transaction 260 may determine that the message criteria has been met. In response to the message transaction 260 determining that the message criteria has been met, the messaging platform 116 may retrieve the adjustment amount from the message transaction 260 and complete execution of the cost transaction associated with the view message type by creating a adjustment in the receiver's earner wallet to add $1.00 thereto, and debiting the $1.00 holding charge from the sender's payer wallet. The messaging platform 117 may set the status of the message transaction 260 to fulfilled and transmit an indication to the sender that the message 250 was viewed by the receiver.

When the receiver wishes to transfer the funds in their earner wallet to their bank account, the messaging application 117B may interface with the third party payment platform 160A and instruct the third party payment platform 160A to complete processing the transfer of the balance of the receiver's earner wallet to the receiver's bank account.

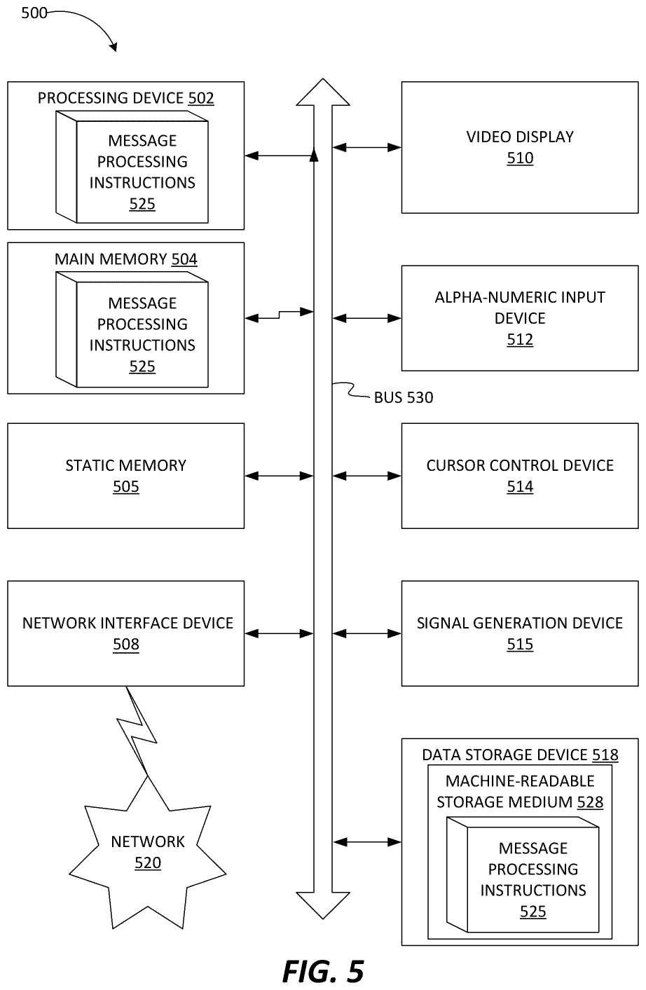

FIG. 5 illustrates a diagrammatic representation of a machine in the example form of a computer system 500 within which a set of instructions, for causing the machine to perform any one or more of the methodologies discussed herein for sending/receiving messages in a messaging platform that uses message types defined by different cost transactions and message criteria to incentivize receivers of messages of those types to prioritize such messages by processing the associated cost transaction based on whether the message criteria associated with the message type is met.

In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, a switch or bridge, a hub, an access point, a network access control device, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In one embodiment, computer system 500 may be representative of a server.

The exemplary computer system 500 includes a processing device 502, a main memory 504 (e.g., read-only memory (ROM), flash memory, dynamic random access memory (DRAM), a static memory 505 (e.g., flash memory, static random access memory (SRAM), etc.), and a data storage device 518, which communicate with each other via a bus 530. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Computing device 500 may further include a network interface device 508 which may communicate with a network 520. The computing device 500 also may include a video display unit 510 (e.g., a liquid crystal display (LCD) or a cathode ray tube (CRT)), an alphanumeric input device 512 (e.g., a keyboard), a cursor control device 514 (e.g., a mouse) and an acoustic signal generation device 515 (e.g., a speaker). In one embodiment, video display unit 510, alphanumeric input device 512, and cursor control device 514 may be combined into a single component or device (e.g., an LCD touch screen).

Processing device 502 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 502 may also be one or more special-purpose processing devices such as an application specific integrated circuit (ASIC), a field programmable gate array (FPGA), a digital signal processor (DSP), network processor, or the like. The processing device 502 is configured to execute peer to peer file transfer instructions 525, for performing the operations and steps discussed herein.

The data storage device 518 may include a machine-readable storage medium 528, on which is stored one or more sets of peer to peer file transfer instructions 525 (e.g., software) embodying any one or more of the methodologies of functions described herein. The peer to peer file transfer instructions 525 may also reside, completely or at least partially, within the main memory 504 or within the processing device 502 during execution thereof by the computer system 500; the main memory 504 and the processing device 502 also constituting machine-readable storage media. The peer to peer file transfer instructions 525 may further be transmitted or received over a network 520 via the network interface device 508.

The machine-readable storage medium 528 may also be used to store instructions to perform a method for object analysis/validation event publishing, as described herein. While the machine-readable storage medium 528 is shown in an exemplary embodiment to be a single medium, the term “machine-readable storage medium” should be taken to include a single medium or multiple media (e.g., a centralized or distributed database, or associated caches and servers) that store the one or more sets of instructions. A machine-readable medium includes any mechanism for storing information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

The preceding description sets forth numerous specific details such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth are merely exemplary. Particular embodiments may vary from these exemplary details and still be contemplated to be within the scope of the present disclosure.

Additionally, some embodiments may be practiced in distributed computing environments where the machine-readable medium is stored on and or executed by more than one computer system. In addition, the information transferred between computer systems may either be pulled or pushed across the communication medium connecting the computer systems.

Embodiments of the claimed subject matter include, but are not limited to, various operations described herein. These operations may be performed by hardware components, software, firmware, or a combination thereof.

Although the operations of the methods herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent or alternating manner.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Furthermore, the terms “first,” “second,” “third,” “fourth,” etc. as used herein are meant as labels to distinguish among different elements and may not necessarily have an ordinal meaning according to their numerical designation.

It will be appreciated that variants of the above-disclosed and other features and functions, or alternatives thereof, may be combined into may other different systems or applications. Various presently unforeseen or unanticipated alternatives, modifications, variations, or improvements therein may be subsequently made by those skilled in the art which are also intended to be encompassed by the following claims. The claims may encompass embodiments in hardware, software, or a combination thereof

What is claimed is:

1. A method comprising:
receiving information defining each of a set of message types, wherein each of the set of message types comprises a cost transaction and message criteria for executing the cost transaction;
receiving, via a user interface (UI) for selecting among the set of messages types, a selection of a message type from the set of messages types and message content;
transmitting a user message having the selected message type and the message content to a receiver device;
creating, by a processing device, a message transaction to monitor one or more actions taken by the receiver device with respect to the user message to determine whether message criteria associated with the selected message type has been satisfied; and
in response to determining that the message criteria associated with the selected message type has been satisfied, processing a cost transaction associated with the selected message type between the sender device and the receiver device.

2. The method of claim 1, further comprising:
providing, by the receiver device, a messaging link via each of a set of platforms, wherein in response to the sender device interacting with the messaging link, the sender device is redirected by the messaging link to the UI for selecting among the set of messages types.

3. The method of claim 1, wherein:
the message criteria associated with the selected message type comprises one or more of:
a first threshold amount of time after receipt of the user message within which the user message must be viewed by the receiver device; and
a second threshold amount of time after receipt of the user message within which a response to the user message must be transmitted by the receiver device; and
the cost transaction associated with the selected message type comprises:
a value that must be debited to a third party payment platform account of the receiver device.

4. The method of claim 3, wherein determining whether the message criteria associated with the selected message type has been satisfied comprises:
determining whether the one or more actions are taken by the receiver device within the first threshold amount of time when the one or more actions include viewing the user message; and
determining whether the one or more actions are taken by the receiver device within the second threshold amount of time when the one or more actions include replying to the user message.

5. The method of claim 1, further comprising:
uploading each of the set of message types to a central repository server as a message type template.

6. The method of claim 5, wherein transmitting the user message having the selected message type and message content comprises:
retrieving a message type template corresponding to the selected message type;
modifying the message type template corresponding to the selected message type with the message content to generate the user message; and
transmitting, via the sender device, the user message to the receiver device.

7. The method of claim 1, wherein the message transaction is created by a messaging platform that comprises a plurality of messaging applications, and wherein each of the sender device and the receiver device execute a respective messaging application of the plurality of messaging applications.

8. A system comprising:
a receiver device to receive information defining each of a set of message types, wherein each of the set of message type templates comprises a cost transaction and message criteria for executing the cost transaction;
a sender device to:
receive, via a user interface (UI) for selecting among the set of messages types, a selection of a message type from the set of messages types and message content; and
transmit a user message having the selected message type and the message content to the receiver device; and
a central messaging server to:
create a message transaction to monitor one or more actions taken by the receiver device with respect to the user message to determine whether message criteria associated with the selected message type has been satisfied; and
in response to determining that the message criteria associated with the selected message type has been satisfied, process a cost transaction associated with the selected message type between the sender device and the receiver device.

9. The system of claim 8, wherein the receiver device is further to:
provide a messaging link via each of a set of platforms, wherein in response to the sender device interacting with the messaging link, the sender device is redirected by the messaging link to the UI for selecting among the set of messages types.

10. The system of claim 8, wherein:
the message criteria associated with the selected message type comprises one or more of:
a first threshold amount of time after receipt of the user message within which the user message must be viewed by the receiver device; and
a second threshold amount of time after receipt of the user message within which a response to the user message must be transmitted by the receiver device; and
the cost transaction associated with the selected message type comprises:
a value that must be debited to a third party payment platform account of the receiver device.

11. The system of claim 10, wherein to determine whether the message criteria associated with the selected message type has been satisfied, the central messaging server is to:
determine whether the one or more actions are taken by the receiver device within the first threshold amount of time when the one or more actions include viewing the user message; and
determine whether the one or more actions are taken by the receiver device within the second threshold amount of time when the one or more actions include replying to the user message.

12. The system of claim 8, wherein the receiver device is further to:
upload each of the set of message types to the central repository server as a message type template.

13. The system of claim 12, wherein to transmit the user message having the selected message type and message content, the sender device is to:
retrieve a message type template corresponding to the selected message type;
modify the message type template corresponding to the selected message type with the message content to generate the user message; and
transmit the user message to the receiver device.

14. The system of claim 8, wherein the central messaging server hosts a messaging platform that comprises a plurality of messaging applications, and wherein each of the sender device and the receiver device execute a respective messaging application of the plurality of messaging applications.

15. A non-transitory computer-readable medium having instructions stored thereon which, when executed by a processing device, cause the processing device to:
receive from a sender device, a user message, wherein the user message comprises a message of a selected type among a set of message types, wherein each of the set of message types comprises a cost transaction and message criteria for executing the cost transaction;
transmit the user message to a receiver device;
create, by the processing device, a message transaction to monitor one or more actions taken by the receiver device with respect to the user message to determine whether message criteria associated with the selected message type has been satisfied; and
in response to determining that the message criteria associated with the selected message type has been satisfied, processing a cost transaction associated with the selected message type between the sender device and the receiver device.

16. The non-transitory computer-readable medium of claim 15, wherein the processing device is further to:
receive, from the receiver device, an indication of the one or more actions taken by the receiver device with respect to the user message.

17. The non-transitory computer-readable medium of claim 15, wherein:
the message criteria associated with the selected message type comprises one or more of:
a first threshold amount of time after receipt of the user message within which the user message must be viewed by the receiver device; and
a second threshold amount of time after receipt of the user message within which a response to the user message must be transmitted by the receiver device; and
the cost transaction associated with the selected message type comprises:
a value that must be debited to a third party payment platform account of the receiver device.

18. The non-transitory computer-readable medium of claim 17, wherein to determine whether the message criteria associated with the selected message type has been satisfied, the processing device is to:
determine whether the one or more actions are taken by the receiver device within the first threshold amount of time when the one or more actions include viewing the user message; and
determine whether the one or more actions are taken by the receiver device within the second threshold amount of time when the one or more actions include replying to the user message.

19. The non-transitory computer-readable medium of claim 15, wherein the processing device is further to:
receive a message type template corresponding to each of the set of message types; and
providing a central repository where each of the message type templates are stored.

20. The non-transitory computer-readable medium of claim 15, wherein the message transaction is created using a messaging platform that comprises a plurality of messaging applications, and wherein each of the sender device and the receiver device execute a respective messaging application of the plurality of messaging applications.
